(19) United States
(12) Patent Application Publication
(10) Pub. No.: US 2015/0277726 A1
(43) Pub. Date: Oct. 1, 2015

(54) SLIDING SURFACE

(71) Applicant: Microsoft Corporation, Redmond, WA (US)

(72) Inventors: Christopher Maloney, San Francisco, CA (US); John Schilling, San Francisco, CA (US); Jonathan Chung, San Francisco, CA (US)

(21) Appl. No.: 14/533,551

(22) Filed: Nov. 5, 2014

Related U.S. Application Data
(60) Provisional application No. 61/973,737, filed on Apr. 1, 2014.

(51) Int. Cl. G06F 3/0484; G06F 3/0482

(52) U.S. Cl. CPC G06F 3/04847; G06F 3/0482; G06F 3/04842

(57) ABSTRACT

Examples of the present disclosure provide a method for maintaining a size of a presentation slide displayed in a presentation editor on a mobile computing device. Specifically, examples disclosed herein provide for displaying a first slide, a full view of a first user interface element proximate the first slide and a partial view of a second user interface element proximate the first slide. Further provided is upon receiving a selection of the second user interface element, displaying a full view of the second user interface element, a partial view of the first user interface element, and the first slide.

### BACKGROUND

Computing devices are often used to view and create presentation slides using a presentation editor. Presentation editors often position user interface elements adjacent to a slide workspace area in order to easily provide a user with information the user readily views and/or selects while editing or viewing a presentation. Accordingly, such user interface elements can occupy a large amount of space on a display of the computing device.

It is with respect to these and other general considerations that examples have been made. Also, although relatively specific problems have been discussed, it should be understood that the examples should not be limited to solving the specific problems identified in the background.

### SUMMARY

This summary is provided to introduce a selection of concepts in a simplified form that are further described below in the Detail Description section. This summary is not intended to identify key features or essential features of the claimed subject matter, nor is it intended to be used as an aid in determining the scope of the claimed subject matter.

Example aspects of the present disclosure provide a method for maintaining a size of a presentation slide displayed in a presentation editor on a computing device, such as a mobile computing device. Specifically, examples disclosed herein provide for displaying a first slide, a full view of a first user interface element, and a partial view of a second user interface element. In examples, the first user interface element is positioned proximate a first side of the first slide and the second user interface element is positioned on a second side, such as the side opposite the first user interface element. In examples, upon receiving a selection of the partial view of the second user interface element, displaying a full view of the second user interface element, a partial view of the first user interface element, and the first slide.

Examples may be implemented as a computer process, a computing system or as an article of manufacture such as a computer program product or computer readable media. The computer program product may be computer storage media readable by a computer system and encoding a computer program of instructions for executing a computer process.

### BRIEF DESCRIPTION OF THE DRAWINGS

Non-limiting and non-exhaustive examples are described with reference to the following FIGs. in which:

FIG. 1 illustrates a mobile tablet device on which a presentation editor operates;

FIG. 2 illustrates a first view of a slide and first and second user interface elements as displayed in a slide workspace area of a presentation editor;

FIG. 3 illustrates second view of a slide and first and second user interface elements as displayed in a slide workspace area of a presentation editor;

FIG. 4 is a first view of an alternative example illustrating a slide and first and second user interface elements as displayed in a slide workspace area of a presentation editor;

FIG. 5 is a second view of the alternative example shown in FIG. 4;

FIG. 6 illustrates a method for shifting elements displayed in a slide workspace area of a presentation editor;

FIG. 7 illustrates a tablet computing device for executing one or more aspects of the present disclosure;

FIG. 8 illustrates a block diagram of a computing environment suitable for implementing one or more aspects disclosed herein;

FIG. 9A illustrates one example of a mobile computing device executing one or more aspects as disclosed herein;

FIG. 9B is a simplified block diagram of an exemplary mobile computing device suitable for practicing one or more aspects disclosed herein;

FIG. 10 is a simplified block diagram of a distributed computing system for practicing one or more aspects disclosed herein.

### DETAILED DESCRIPTION

Various examples are described more fully below with reference to the accompanying drawings, which form a part hereof, and which show specific exemplary examples. However, examples may be implemented in many different forms and should not be construed as limited to the examples set forth herein; rather, these examples are provided so that this disclosure will be thorough and complete, and will fully convey the scope of the examples to those skilled in the art. Examples may be practiced as methods, systems or devices. Accordingly, examples may take the form of a hardware implementation, an entirely software implementation or an implementation combining software and hardware aspects. The following detailed description is, therefore, not to be taken in a limiting sense.

In examples described herein, a “display” refers generally to a visual output device. One of skill in the art will appreciate that “display” may refer a variety of visual output devices including but not limited to displays utilizing LED-, LCD-, CRT-, plasma-, and OLED-display technology. A display may also generally refer to a touch screen for viewing and identifying visual objects on a device such as a tablet computing device or a phone. As described herein, displays may incorporate one or more computing devices or components of computing devices, including but not limited to processors, memory, communications interfaces, and wireless hardware, including technology conforming to various standards such as the Bluetooth and IEEE 802.11 standards.

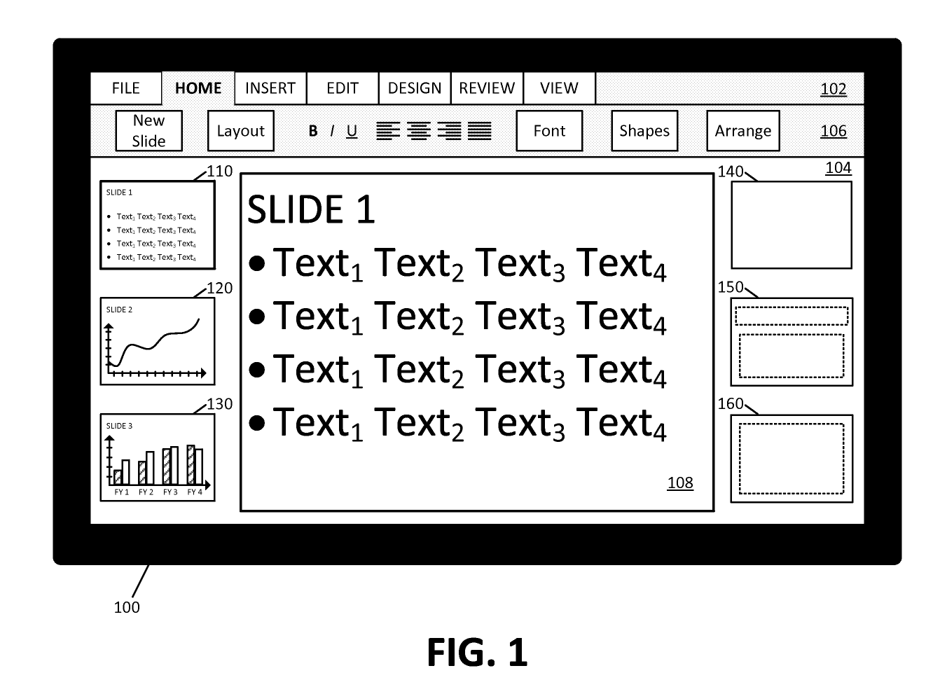

Referring generally to the systems and methods of FIGS. 1-10, the examples disclosed herein describe systems and methods for organizing the slide workspace area in a presentation editor operated on a computing device, such as a tablet computer or a mobile phone. In particular, examples of the present disclosure discloses maintaining the size of the slide while also providing access to user interface elements that are positioned proximate each side of a presentation slide. As described herein, user interface elements represent selectable elements useable by a presentation creator or viewer (“user”). Generally, user interface elements refer to, for example, slide thumbnails, which represent a scaled down version of the displayed and contiguous slides, slide layout suggestions, user notes, comments, or task panes, such as formatting task panes for text, shapes, charts, and other objects.

Accordingly, user interface elements contain readily utilized functionality when creating or viewing a presentation in a presentation editor. Examples of the present disclosure makes it possible for a user to obtain easy access to such user interface elements positioned on each side of the slide while also maintaining the overall size of the slide when creating or viewing a presentation on a computing device such as, for example, a tablet or a mobile phone.

Referring now to FIG. 1 illustrates an example mobile tablet device 100 on which an example presentation editor 102 operates is shown. As illustrated, the presentation editor 102 displayed on the tablet device 100 includes a slide workspace area 104 and a toolbar 106. Displayed on the example slide workspace area 104 are: a slide 108, a first user interface element 110, a second user interface element 120, a third user interface element 130, a fourth user interface element 140, a fifth user interface element 150, and a sixth user interface element 160. In this example, user interface elements 110-130 are thumbnail views of slides in the slide deck, including a thumbnail of slide 108 and other slides in the slide deck that are not currently being displayed at full size in slide workspace area 104. If a user were to select the “SLIDE 2” user interface element 120, then “SLIDE 2” would be displayed at full size in slide workspace area 104. Further, in this example, user interface elements 140-160 display thumbnails for slide layout suggestions for the sides in the slide deck.

Additionally, displayed in the example toolbar 106 are tabs 102, such as, “File,” “Home,” “Insert,” “Edit,” “Design,” “Review,” and “View.” As illustrated in this example, the “Home” tab is selected, thereby displaying example commands, such as, “New Slide;” “Layout;” “Font;” “Shapes;” “Arrange;” font emphasis, such as bold, italics, and underline; and paragraph layout options.

In this example illustration, the user interface elements 110-160 and the toolbar 106 are positioned proximate the slide 108 and therefore limit the size of the slide 108. In examples, the toolbar 106 is entirely hidden from view and therefore does not interfere with the size of the slide 108. However, hiding the user interface elements 110-160 may not be a desirable option. In some examples, an aspect of the user interface elements 110-160 is to provide the user with guidance while creating the presentation. For example, a user may wish to view user interface elements 110-130, which illustrate slides, as thumbnails, in the slide deck to determine what content to add to a particular slide or which order to arrange the slides. Additionally, a user may wish to view user interface elements 140-160, which display slide layout suggestions associated with the active slide 108. Accordingly, aspects of the present disclosure increase, or optimize the size of the slide 108 displayed on the tablet computing device 100, while still providing views and easy access to the user interface elements 110-160.

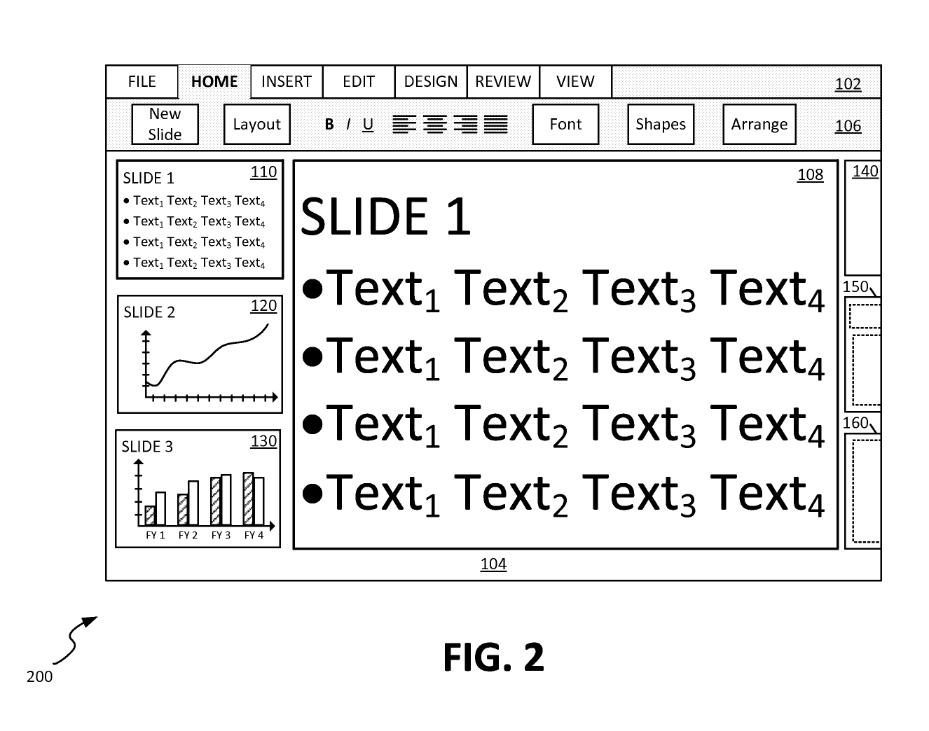

Referring now to FIG. 2, shown is an example of a first view 200 of a slide workspace area 104 of a presentation editor 102, wherein the slide workspace area 104 displays a slide 108, a full view of user interface elements 110-130 and partial views of user interface elements 140-160. As illustrated, the user interface elements 140-160 are partially displayed in the slide workspace area 104, thereby making available the space that was otherwise occupied by the now hidden portion of the user interface elements 140-160. Accordingly, the slide 108 occupies this available space of the slide workspace area 104, thereby increasing in size relative to the slide 108 illustrated in FIG. 1.

The user interface elements 140-160, although partially in view, are visible in full view when selected. For example, a user may tap on an area occupying the partial view of one of the user interface elements 140-160. Alternatively, the user may swipe the screen of the mobile tablet computing device 100 from the right to the left in order to display a full view of the user interface elements 140-160. These principles are described in further detail below.

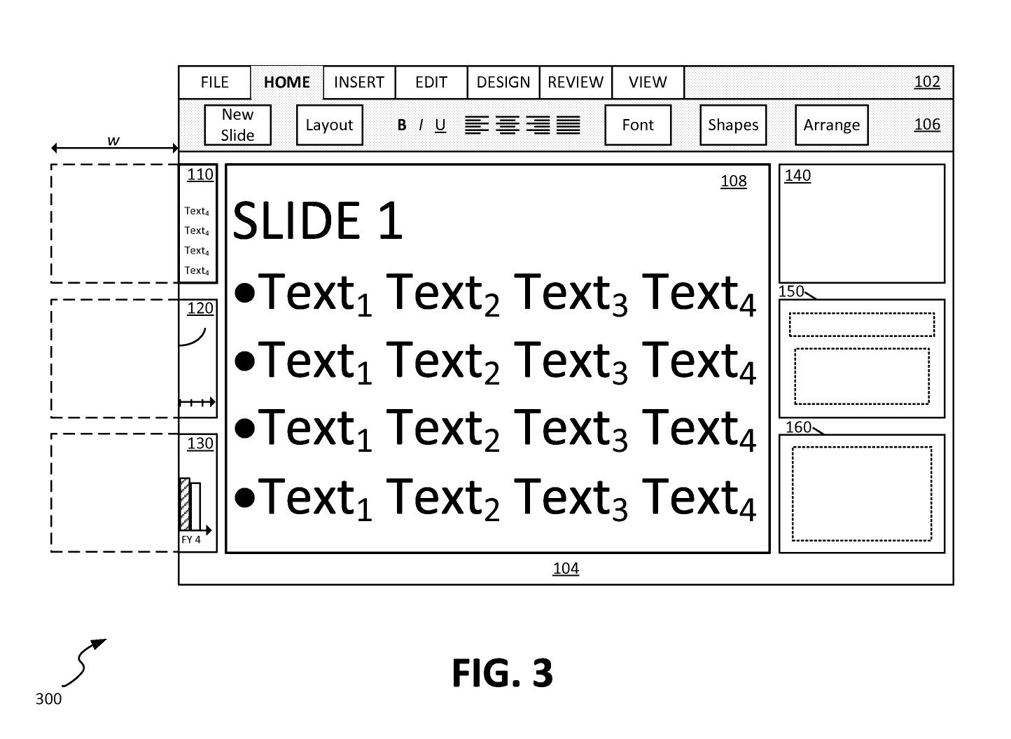

Now referring to FIG. 3, shown is an example of a second view 300 of a slide workspace area 104 of a presentation editor 102, wherein the slide workspace area 104 displays a slide 108, a full view of user interface elements 140-160. In this example view 300, the slide workspace area 104 also displays a partial view of user interface elements 110-130. As described above, upon selection of an area occupying the partial view of any of user interface elements 140-160, as shown in FIG. 2, user interface elements 110-130, slide 108, and user interface elements 140-160 are rearranged to allow a full view of the user interface elements 140-160. As illustrated, although user interface elements 140-160 are displayed in full view, the size of the slide 108 is maintained, while also displaying a partial view of user interface elements 110-130. In an example, the rearrangement is performed by shifting each of the user interface elements 110-160 and the slide 108 laterally, thereby shielding a portion of either user interface elements 110-130 or user interface elements 140-160 from full view at a given time. Accordingly, the amount of slide workspace area 104 conserved and now useable by the slide 108 is indicated by width, w (dashed lines).

As noted above, in this example, user interface elements 140-160 display suggested slide layouts for the slides in the slide deck of the presentation. In some example aspects, a user may select one of the user interface elements 140-160 to rearrange the layout of the slide 108. In other examples, the user interface elements 140-160 may be a single user interface element corresponding to notes and comments associated with the slide 108, wherein a user may directly type notes associated with the slide 108. In some aspects, the notes user interface element may expand to a larger display, or may be displayed along the bottom of the display. In such aspects, the toolbar 106 may be minimized, thereby allowing the size of the slide 108 to be maintained in the slide workspace area 104. In other aspects, upon selection of one of the slide layout suggestions of user interface elements 140-160, each of the slide layout suggestions are displayed at full size in the slide workspace area 104, in which case the slide layout suggestions being displayed at full size in the slide workspace area 104 would be considered the “slide 108,” as the slide layout suggestions would occupy the main display space of slide workspace area 104. Accordingly, slide 108 refers generally to the main display space of workspace area 104, regardless of the content then being displayed.

In other aspects, the user interface elements 140-160 may include elements that, when selected, interact with portions of the slide being displayed in slide workspace area 104. For example, user interface element 112 may include task panes, such as formatting task panes for text, shapes, charts, and other objects. Upon selection of a particular task pane in user interface elements 140-160, a selected formatting may be inserted into the slide displayed in slide workspace area 104. For example, the user interface elements 140-160 may include pictures that may be selected to be inserted into the slide 108 displayed in slide workspace area 104.

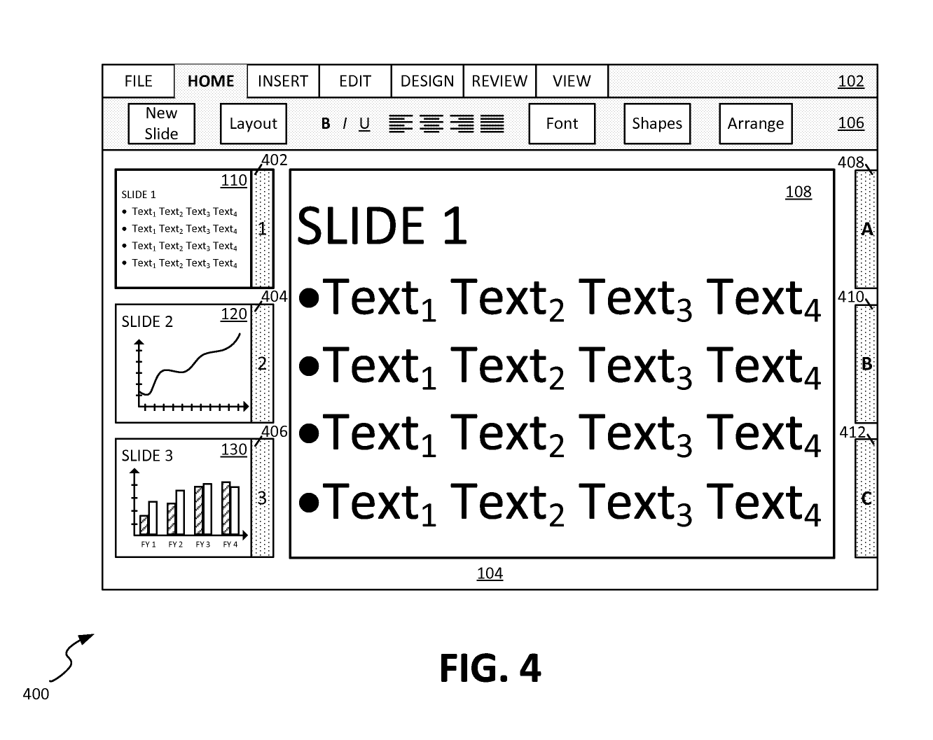

Now referring to FIG. 4, a first view 400 of an alternative example illustrating a slide 108 and a full view of user interface elements 110-130, as displayed in a slide workspace area 104 of a presentation editor 102 is shown. Also shown in this alternative example, are tags 402-412 each associated with, and identify user interface elements 110-160, respectively Accordingly, in this example view 400, tag 1 (402), tag 2 (404), tag 3 (406), which are associated with user interface elements 110-130; and tag A (408), tag B (410), and tag C (420), which are associated with user interface elements 140-160 are visible, thereby indicating the thumbnail with which it is associated. In practice, tag 1 (402), tag 2 (404), tag 3 (406) might be labeled “SLIDE 1,” “SLIDE 2,” and “SLIDE 3,” respectively, (or some other descriptive label or icon) to easily identify the thumbnails to which they are associated. Similarly, tag A (408), tag B (410), and tag C (420) might be labeled “LAYOUT 1,” “LAYOUT 2,” and “LAYOUT 3,” respectively. In examples, to save display space, tag 1 (402), tag 2 (404), and tag 3 (406), which respectively correspond to user interface elements 110-130, might not be displayed if the full view of user interface elements 110-130 are being displayed, as the identification of those thumbnails would be obvious to the user. Additionally shown, in view 400, tag A (408), tag B (410), and tag C (420) are displayed but no other portions of corresponding user interface elements 140-160 are displayed. This shall still be considered a partial display of user interface elements 140-160, as used herein.

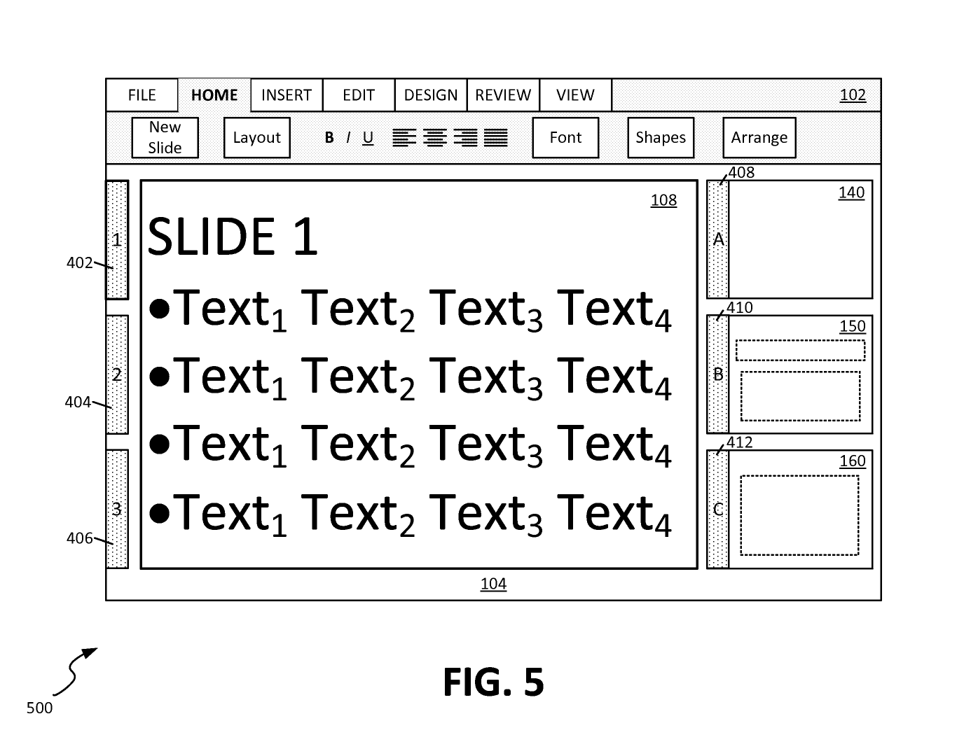

Now referring to FIG. 5, shown is a second view 500 of an alternative example illustrating a slide 108 and a full view of user interface elements 140-160, as displayed in a slide workspace area 104 of a presentation editor 102, and a partial view of user interface elements 110-130. Also shown in this alternative example are tags 402-406, each associated with user interface elements 110-160 . As illustrated in this view 500 of the alternative example, although a full view of user interface elements 140-160 are displayed, the size of the slide 108 is maintained relative to the first view 400. In this view 500, tag 1 (402), tag 2 (404), tag 3 (406), which are associated with user interface elements 110-130; and tag A (408), tag B (410), and tag C (420), which are associated with user interface elements 140-160, are visible, thereby indicating the thumbnail with which it is associated. In examples, to save display space, tag A (408), tag B (410), and tag C (420), which respectively correspond to user interface elements 140-160, might not be displayed if the full view of user interface elements 140-160 are displayed, as identification of the thumbnails would be obvious to the user. Additionally shown, in view 500, tag 1 (402), tag 2 (404), tag 3 (406) may be displayed but no other portions of user interface elements 110-130 are displayed. This shall still be considered a partial display of user interface elements 110-130, as used herein.

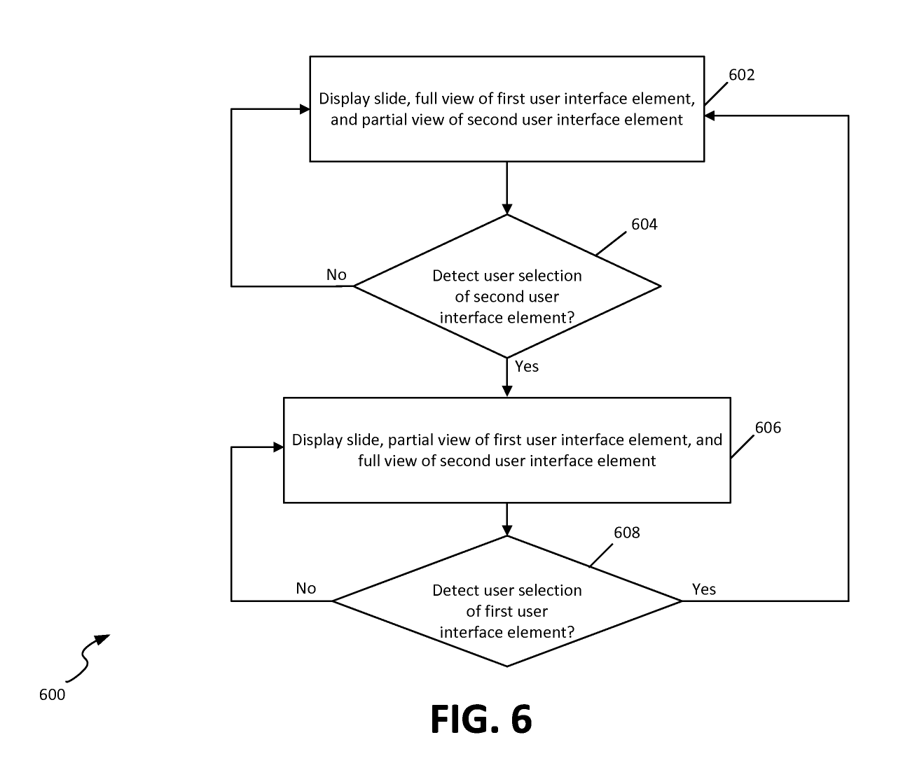

Now referring to FIG. 6, a method for organizing user interface elements displayed in a slide workspace area is described. In operation 602, a slide, a full view of a user interface elements 110-130 and a partial view of user interface elements 140-160 are displayed.

In operation 604, a determination is made whether a user selection of one of user interface elements 140-160 has been detected. Detection of a user selection can refer to, for example, detection of tapping, clicking, or highlighting an area of a display associated with user interface elements 140-160. Alternatively, detection of a selection can refer to detection of swiping a display to a right or left position in order to display a full view of either user interface elements 110-160. If a user selection of any one of user interface elements 140-160 is not detected in operation 604, flow proceeds to operation 602. Swiping need not be started by touching the area of the second user interface element so long as it is understood as an indication that the user desires that user interface elements 140-160 be displayed in full. Accordingly, the slide, the full view of user interface elements 110-130 and a partial view of user interface elements 140-160 continue to be displayed.

However, if a user selection of any one of the user interface elements 140-160 is detected in operation 604 flow proceeds to operation 606, where the slide 108, a partial view of user interface elements 110-130, and a full view of user interface elements 140-160 are displayed. For example, as described herein in relation to FIGS. 2-5, the presentation editor 102 may rearrange user interface elements 110-130, the slide 108, and user interface elements 140-160. In some aspects, this rearrangement is performed by shifting user interface elements 110-160 and the slide 108 between right and left positions, thereby shielding a portion of either the user interface elements 110-130 or user interface elements 140-160 from full view at a given time.

In operation 608, a determination is made whether a user selection of user interface elements 110-130 has been detected. As described above, detection of a user selection can refer to, for example, detection of tapping, clicking, or highlighting an area of a display associated with user interface elements 140-160. Alternatively, detection of a selection can refer to detection of swiping a display to a right or left position in order to display a full view of any of the user interface elements 110-160. If a user selection of user interface elements 110-130 is not detected in operation 608, flow proceeds to operation 606. Swiping need not be started by touching the area of the user interface elements 110-130 so long as it is understood as an indication that the user desires that the user interface elements 110-130 be displayed in full. Accordingly, the slide 108, the full view of user interface elements 140-160 and a partial view of user interface elements 110-130 continue to be displayed.

However, if a user selection of any one of user interface elements 110-130 is detected in operation 608 flow proceeds to operation 602, where the slide, a full view of user interface elements 110-130, and a partial view of user interface elements 140-160 are displayed. For example, as described herein in relation to FIGS. 2-5, the presentation editor 102 may rearrange user interface elements 110-130, the slide 108, and user interface elements 140-160. In some examples, this rearrangement is performed by shifting user interface elements 110-130, the slide 108, and user interface elements 140-160 between right and left positions, thereby shielding a portion of either user interface elements 110-130 or user interface elements 140-160 from full view at a given time.

Although the examples illustrated and described herein refer to displaying of user interface elements adjacent to either side of the slide, it is not limited to this scope. In particular, user interface elements may be positioned above or below slide or diagonally from the slide. Alternatively, user interface elements may be positioned above, below, and on either side of, and diagonally from, the slide. Additionally, although examples herein are described with reference to a mobile computing device, this is not intended to be limiting and thus the examples herein may be used on any display device where minimization of space for user interface elements is desired. Additionally, the examples herein are not limited to a slide presentation program, but can alternatively be used with respect to other programs where a main information section of the display is desired to be maximized with respect to the display area for user interface elements.

As illustrated, the example aspects of the present disclosure provide improved efficiency for users who are viewing or editing a presentation on a mobile device, such as a mobile phone, a tablet computing device, or a miniature laptop. The efficient use of the slide workspace area 104 provides an improved slide and text display that maximizes the use of the computing device display area, which in turn improves user readability and efficiency. Such efficient use of display space further improves a user's interaction and reduces a user's error rate as the user interacts with the presentation editor. Such improved use of display space further contributes to the enhancement of presentation editors by providing increased functionality as presentation editors are operated on miniature devices such as tablet computing devices, mobile phones, and miniature laptops.

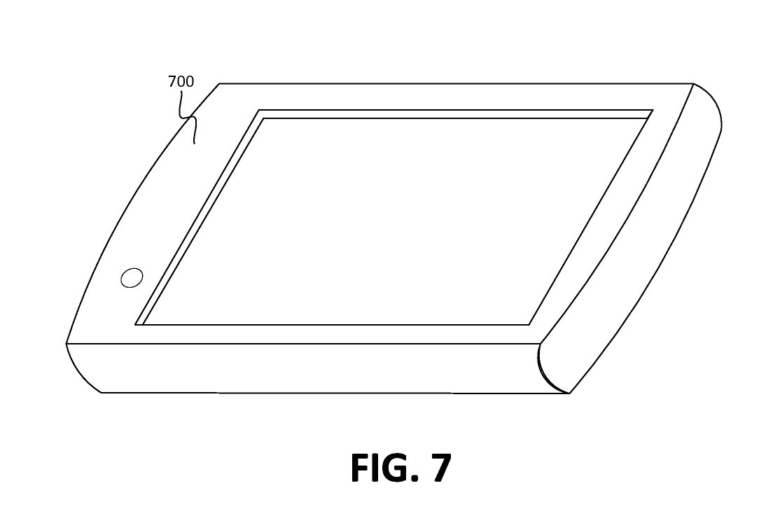

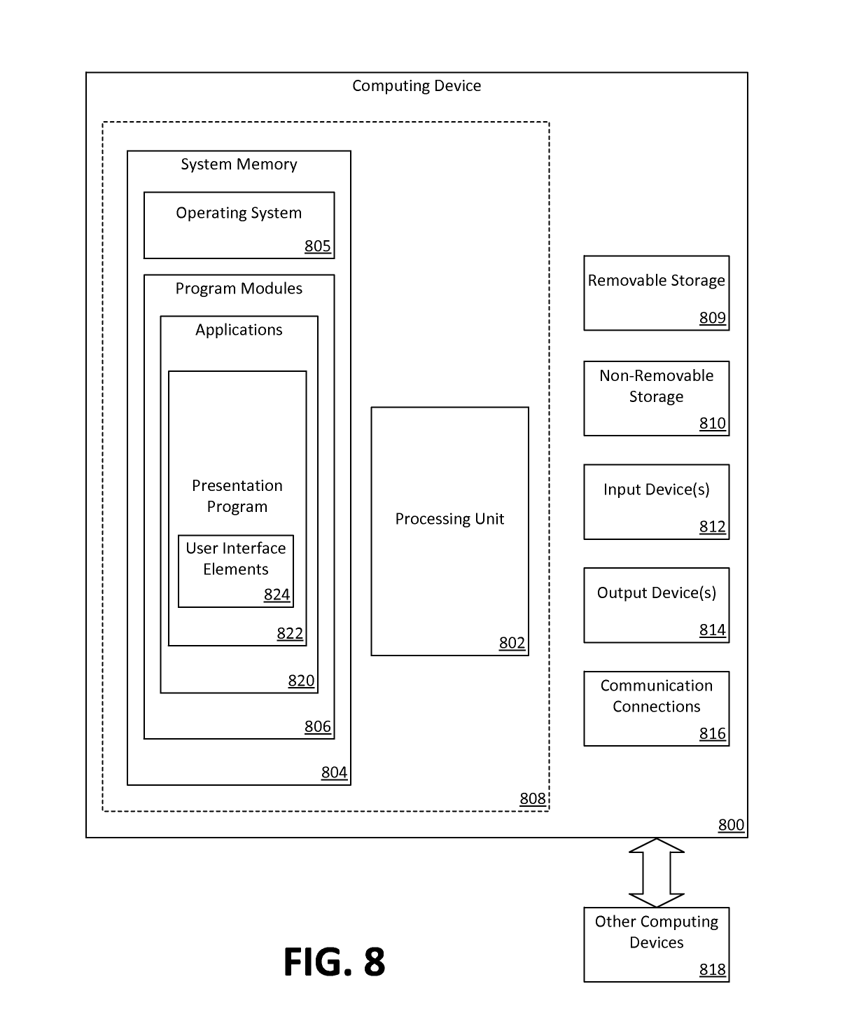

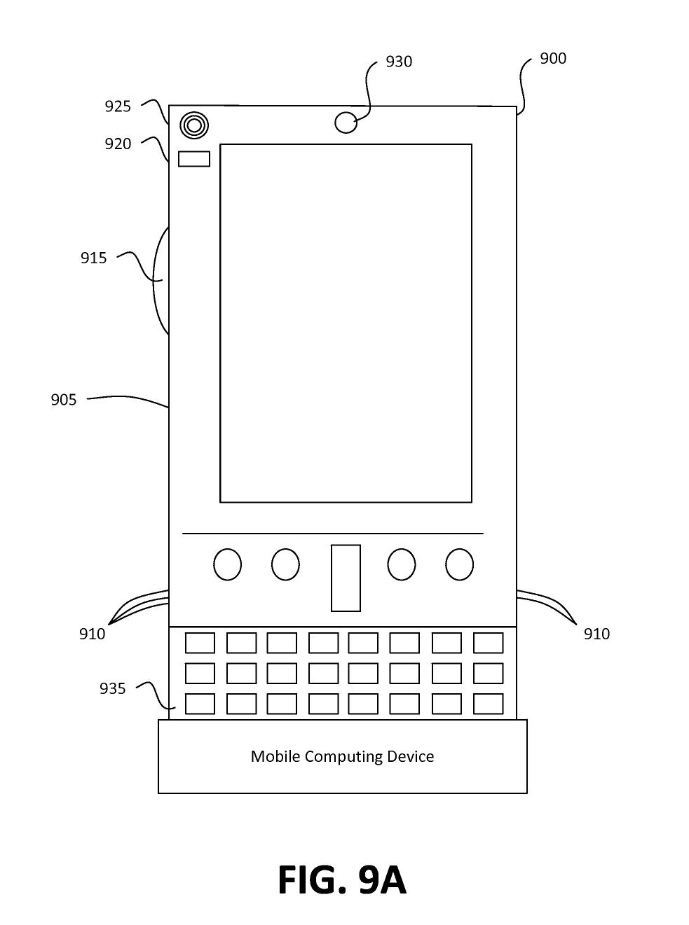

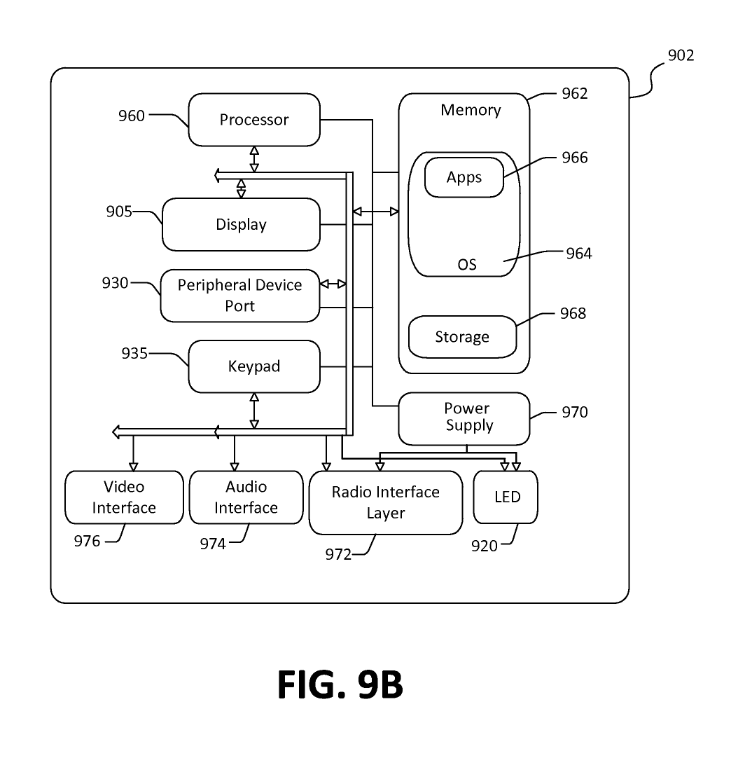

The examples and functionalities described herein may operate via a multitude of computing systems including, without limitation, wired and wireless computing systems, mobile computing systems (e.g., mobile telephones, netbooks, tablet or slate type computers, and laptop computers). FIG. 7 illustrates an exemplary tablet computing device 700 that may execute one or more examples disclosed herein. In addition, the examples and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which examples of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIGS. 8 through 9B and the associated descriptions provide a discussion of a variety of operating environments in which examples of the present disclosure may be practiced. However, the devices and systems illustrated and discussed with respect to FIGS. 8 through 9B are for purposes of example and illustration and are not limiting of a vast number of computing device configurations that may be utilized for practicing examples of the present disclosure, described herein.

FIG. 8 is a block diagram illustrating exemplary physical components of a computing device 800 with which examples of the present disclosure may be practiced. The computing device components described below may be suitable for the computing devices described above. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination. The system memory 804 may include an operating system 805, one or more program modules 806, which are suitable for running applications 820, such as a presentation program 822 on which user interface elements 824, as described herein, are displayed. The operating system 805, for example, may be suitable for controlling the operation of the computing device 800. Furthermore, examples of the present disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 may perform processes including, for example, one or more of the stages of the methods described herein. The aforementioned process is an example, and the processing unit 802 may perform other processes. Other program modules that may be used in accordance with aspects of the present disclosure may include electronic mail and contacts applications, word processing applications, spreadsheet applications, database applications, slide presentation applications, drawing or computer-aided application programs, etc.

Generally, consistent with aspects of the present disclosure, program modules may include routines, programs, components, data structures, and other types of structures that may perform particular tasks or that may implement particular abstract data types. Moreover, aspects of the present disclosure may be practiced with other computer system configurations, including hand-held devices, multiprocessor systems, microprocessor-based or programmable consumer electronics, minicomputers, mainframe computers, and the like. Aspects of the present disclosure may also be practiced in distributed computing environments where tasks are performed by remote processing devices that are linked through a communications network. In a distributed computing environment, program modules may be located in both local and remote memory storage devices.

Furthermore, aspects of the present disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the present disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein may be operated via application-specific logic integrated with other components of the computing device 800 on the single integrated circuit (chip). Aspects of the present disclosure may also be practiced using other technologies capable of performing logical operations such as, for example, AND, OR, and NOT, including but not limited to mechanical, optical, fluidic, and quantum technologies. In addition, aspects of the present disclosure may be practiced within a general purpose computer or in any other circuits or systems.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal. The computing device 800 may also have one or more input device(s) 812 such as a keyboard, a mouse, a pen, a sound input device, a touch input device, etc. The output device(s) 814 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The computing device 800 may include one or more communication connections 816 allowing communications with other computing devices 818. Examples of suitable communication connections 816 include, but are not limited to, RF transmitter, receiver, and/or transceiver circuitry; universal serial bus (USB), parallel, and/or serial ports.

FIGS. 9A and 9B illustrate a mobile computing device 900, for example, a mobile telephone, a smart phone, a tablet personal computer, a laptop computer, and the like, with which aspects of the present disclosure may be practiced. With reference to FIG. 9A, an exemplary mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative examples, mobile computing device 900 may incorporate more or less input elements. For example, the display 905 may not be a touch screen in some aspects. In yet another alternative example, the mobile computing device 900 is a portable phone system, such as a cellular phone. The mobile computing device 900 may also include an optional keypad 935. Optional keypad 935 may be a physical keypad or a “soft” keypad generated on the touch screen display. In various examples, the output elements include the display 905 for showing a graphical user interface (GUI), a visual indicator 920 (e.g., a light emitting diode), and/or an audio transducer 925 (e.g., a speaker). In some examples, the mobile computing device 900 incorporates a vibration transducer for providing the user with tactile feedback. In yet another example, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

Although described herein in combination with the mobile computing device 900, in alternative examples, features of the present disclosure may be used in combination with any number of computer systems, such as desktop environments, laptop or notebook computer systems, multiprocessor systems, micro-processor based or programmable consumer electronics, network PCs, mini computers, main frame computers and the like. Examples of the present disclosure may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate examples of the present disclosure.

FIG. 9B is a block diagram illustrating the architecture of one example of a mobile computing device. That is, the mobile computing device 900 can incorporate a system (i.e., an architecture) 902 to implement some examples. In one example, the system 902 is implemented as a “smart phone” capable of running one or more applications (e.g., browser, e-mail, calendaring, contact managers, messaging clients, games, and media clients/players). In some examples, the system 902 is integrated as a computing device, such as an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as e-mail or other messages used by an e-mail application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900.

The system 902 has a power supply 970, which may be implemented as one or more batteries. The power supply 970 might further include an external power source, such as an AC adapter or a powered docking cradle that supplements or recharges the batteries.

The system 902 may also include a radio 972 that performs the function of transmitting and receiving radio frequency communications. The radio 972 facilitates wireless connectivity between the system 902 and the “outside world”, via a communications carrier or service provider. Transmissions to and from the radio 972 are conducted under control of the operating system 964. In other words, communications received by the radio 972 may be disseminated to the application programs 966 via the operating system 964, and vice versa.

The visual indicator 920 may be used to provide visual notifications, and/or an audio interface 974 may be used for producing audible notifications via the audio transducer 925. In the illustrated example, the visual indicator 920 is a light emitting diode (LED) and the audio transducer 925 is a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 925, the audio interface 974 may also be coupled to a microphone to receive audible input, such as to facilitate a telephone conversation. In accordance with examples of the present disclosure, the microphone may also serve as an audio sensor to facilitate control of notifications, as will be described below. The system 902 may further include a video interface 976 that enables an operation of an on-board camera 930 to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9B by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio 972 or via a distributed computing network. Similarly, such data/information may be readily transferred between computing devices for storage and use according to well-known data/information transfer and storage means, including electronic mail and collaborative data/information sharing systems.

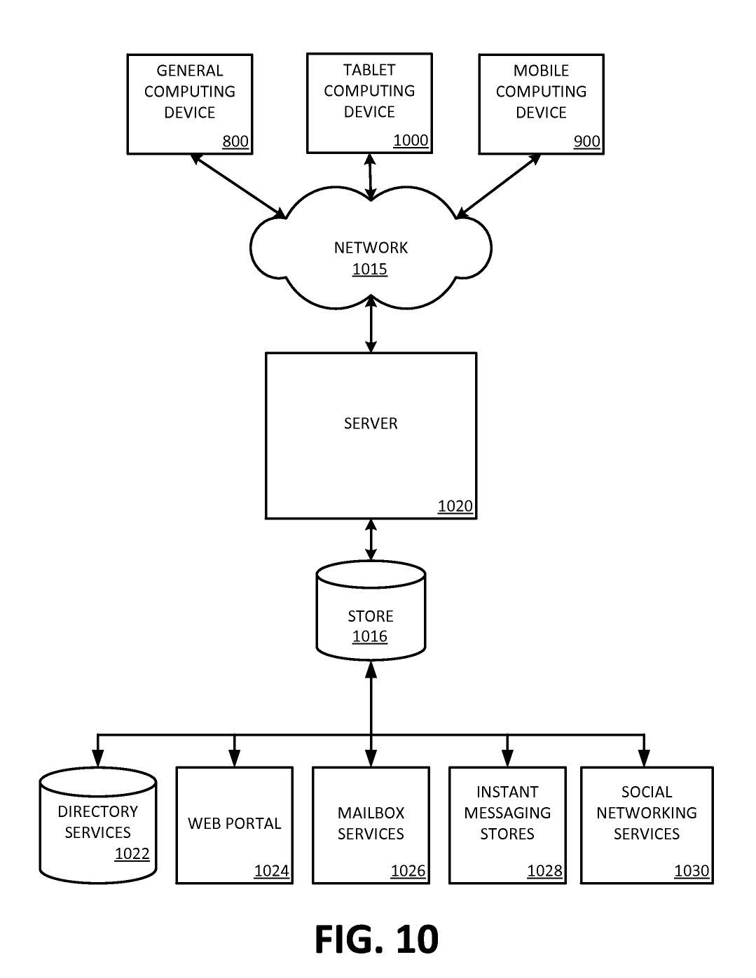

FIG. 10 illustrates one example of the architecture of a system for providing detection and grouping of graphics elements in a fixed format document to one or more client devices, as described above. Content developed, interacted with, or edited may be stored in different communication channels or other storage types. For example, various documents may be stored using a directory service 1022, a web portal 1024, a mailbox service 1026, an instant messaging store 1028, or a social networking site 1030. An application for implementing the examples disclosed herein may use any of these types of systems or the like for enabling data utilization, as described herein. A server 1020 may provide the application to clients. As one example, the server 1020 may be a web server providing the application over the web. The server 1020 may provide the application over the web to clients through a network 1015. By way of example, the client computing device may be implemented as the computing device 800 and embodied in a personal computer, a tablet computing device 1000 and/or a mobile computing device 900 (e.g., a smart phone). Any of these examples of the client computing device 800, 1000, 900 may obtain content from the store 1016.

One skilled in the relevant art may recognize, however, that the examples may be practiced without one or more of the specific details, or with other methods, resources, materials, etc. In other instances, well known structures, resources, or operations have not been shown or described in detail merely to avoid obscuring aspects of the examples.

The description and illustration of one or more examples provided in this application are not intended to limit or restrict the scope of the invention as claimed in any way. The examples and details provided in this application are considered sufficient to convey possession and enable others to make and use the best mode of claimed invention. The claimed invention should not be construed as being limited to any example or detail provided in this application. Regardless of whether shown and described in combination or separately, the various features (both structural and methodological) are intended to be selectively included or omitted to produce an example with a particular set of features. Having been provided with the description and illustrate on of the present disclosure, one skilled in the art may envision variations, modifications, and alternate examples falling within the spirit of the broader aspects of the general inventive concept embodied in this application that do not depart from the broader scope of the claimed invention.

Among other examples, the present disclosure presents systems including: at least one processor; and a memory operatively coupled to the at least one processor and including instructions that, when executed by the at least one processor, cause the at least one processor to perform a method, the method comprising: displaying: a slide; a full view of a first user interface element proximate the first slide; and a partial view of a second user interface element proximate the first slide; and upon receiving a selection of the second user interface element, displaying: a full view of the second user interface element; a partial view of the first user interface element; and the slide. In further examples, upon receiving the selection of the second user interface element, shifting the slide to display the full view of the second user interface element and the partial view of the first user interface element. In further examples, the first user interface element is positioned on a first side of the slide and the second slide is positioned on an opposite side of the slide. In further examples, the display of the partial view of the first user interface element further comprises displaying a tag associated with the first user interface element. Still further, in examples, after receiving a selection of the second user interface element, receiving a selection of the first user interface element; upon receiving a selection of the first user interface element, displaying: a full view of the first user interface element; a partial view of the second user interface element; and the slide. In further examples, the display of the partial view of the second user interface element further comprises displaying a second tag associated with the second user interface element. In further examples, wherein the first user interface element is a slide thumbnail. In further examples, the second user interface element is selected from a group consisting of: a slide layout suggestion, a slide thumbnail, user notes, and a formatting task pane. In further examples, the first user interface element and the second user interface element further comprise a tag for identifying the first user interface element and the second user interface element. In further examples, a size of the slide remains constant in the displaying steps.

Further aspects disclosed herein provide exemplary methods for maintaining a size of a presentation slide displayed in a presentation editor on a mobile computing device, the method comprising: displaying: a slide; a full view of a first user interface element proximate the first slide; and a partial view of a second user interface element proximate the first slide; and upon receiving a selection of the second user interface element, displaying: a full view of the second user interface element; a partial view of the first user interface element; and the slide. In further examples, upon receiving the selection of the second user interface element, shifting the slide to display the full view of the second user interface element and the partial view of the first user interface element. In further examples, the first user interface element is positioned on a first side of the slide and the second slide is positioned on an opposite side of the slide. In further examples, the display of the partial view of the first user interface element further comprises displaying a tag associated with the first user interface element. In further examples, after receiving a selection of the second user interface element, receiving a selection of the first user interface element; upon receiving a selection of the first user interface element, displaying: a full view of the first user interface element; a partial view of the second user interface element; and the slide. In further examples, the display of the partial view of the second user interface element further comprises displaying a second tag associated with the second user interface element. In further examples, a size of the slide remains constant in the displaying steps.

Further aspects disclosed herein provide exemplary computer-readable memory, comprising: displaying: a slide; a full view of a first user interface element proximate the first slide; and a partial view of a second user interface element proximate the first slide; and upon receiving a selection of the second user interface element, displaying: a full view of the second user interface element; a partial view of the first user interface element; and the slide. In further examples, after receiving a selection of the second user interface element, receiving a selection of the first user interface element; upon receiving a selection of the first user interface element, displaying: a full view of the first user interface element; a partial view of the second user interface element; and the slide. In further examples, a size of the slide remains constant in the displaying steps.

The examples described herein may be employed using software, hardware, or a combination of software and hardware to implement and perform the systems and methods disclosed herein. Although specific devices have been recited throughout the disclosure as performing specific functions, one of skill in the art will appreciate that these devices are provided for illustrative purposes, and other devices can be employed to perform the functionality disclosed herein without departing from the scope of the disclosure.

This disclosure described some examples of the present technology with reference to the accompanying drawings, in which only some of the possible aspects were described. Other aspects can, however, be embodied in many different forms and the specific examples disclosed herein should not be construed as limited to the various aspects of the disclosure set forth herein. Rather, these exemplary aspects were provided so that this disclosure was thorough and complete and fully conveyed the scope of the other possible examples to those skilled in the art. For example, aspects of the various examples disclosed herein may be modified and/or combined without departing from the scope of this disclosure.

Although specific examples were described herein, the scope of the technology is not limited to those specific examples. One skilled in the art will recognize other examples or improvements that are within the scope and spirit of the present technology. Therefore, the specific structure, acts, or media are disclosed only as illustrative examples. The scope of the technology is defined by the following claims and any equivalents therein.

What is claimed is:

1. A system including:
at least one processor; and
a memory operatively coupled to the at least one processor and including instructions that, when executed by the at least one processor, cause the at least one processor to perform a method, the method comprising:
displaying:
a slide;
a full view of a first user interface element proximate the first slide; and
a partial view of a second user interface element proximate the first slide; and
upon receiving a selection of the second user interface element, displaying:
a full view of the second user interface element;
a partial view of the first user interface element; and
the slide.

2. The system of claim 1, wherein upon receiving the selection of the second user interface element, shifting the slide to display the full view of the second user interface element and the partial view of the first user interface element.

3. The system of claim 1, wherein the first user interface element is positioned on a first side of the slide and the second slide is positioned on an opposite side of the slide.

4. The system of claim 1, wherein the display of the partial view of the first user interface element further comprises displaying a tag associated with the first user interface element.

5. The system of claim 1, further comprising:
after receiving a selection of the second user interface element, receiving a selection of the first user interface element;
upon receiving a selection of the first user interface element, displaying:
a full view of the first user interface element;
a partial view of the second user interface element; and
the slide.

6. The system of claim 5, wherein the display of the partial view of the second user interface element further comprises displaying a second tag associated with the second user interface element.

7. The system of claim 1, wherein the first user interface element is a slide thumbnail.

8. The system of claim 1, wherein the second user interface element is selected from a group consisting of: a slide layout suggestion, a slide thumbnail, user notes, and a formatting task pane.

9. The system of claim 1, wherein the first user interface element and the second user interface element further comprise a tag for identifying the first user interface element and the second user interface element.

10. The system of claim 1, wherein a size of the slide remains constant in the displaying steps.

11. A method for maintaining a size of a presentation slide displayed on a mobile computing device, the method comprising:
displaying:
a slide;
a full view of a first user interface element proximate the first slide; and
a partial view of a second user interface element proximate the first slide; and
upon receiving a selection of the second user interface element, displaying:
a full view of the second user interface element;
a partial view of the first user interface element; and
the slide.

12. The method of claim 11, wherein upon receiving the selection of the second user interface element, shifting the slide to display the full view of the second user interface element and the partial view of the first user interface element.

13. The method of claim 11, wherein the first user interface element is positioned on a first side of the slide and the second slide is positioned on an opposite side of the slide.

14. The method of claim 11, wherein the display of the partial view of the first user interface element further comprises displaying a tag associated with the first user interface element.

15. The method of claim 11, further comprising:
after receiving a selection of the second user interface element, receiving a selection of the first user interface element;
upon receiving a selection of the first user interface element, displaying:
a full view of the first user interface element;
a partial view of the second user interface element; and
the slide.

16. The method of claim 11, wherein the display of the partial view of the second user interface element further comprises displaying a second tag associated with the second user interface element.

17. The method of claim 11, wherein a size of the slide remains constant in the displaying steps.

18. A computer storage medium comprising computer executable instructions that, when executed by at least one processor, perform a method for maintaining a size of a presentation slide, the method comprising:
displaying:
a slide;
a full view of a first user interface element proximate the first slide; and
a partial view of a second user interface element proximate the first slide; and
upon receiving a selection of the second user interface element, displaying:
a full view of the second user interface element;
a partial view of the first user interface element; and
the slide.

19. The computer-readable memory of claim 18, further comprising:
after receiving a selection of the second user interface element, receiving a selection of the first user interface element;
upon receiving a selection of the first user interface element, displaying:
a full view of the first user interface element;
a partial view of the second user interface element; and
the slide.

20. The computer-readable memory of claim 18, wherein a size of the slide remains constant in the displaying steps.
